(19) United States
(12) Patent Application Publication
(10) Pub. No.: US 2007/0106554 A1
(43) Pub. Date: May 10, 2007

(54) Method and apparatus for providing flexible travel discounts to travelers

(76) Inventors: Paul Manns, Rochester, MI (US); David Meads, Grand Blanc, MI (US)

Correspondence Address: KENYON & KENYON LLP, 1500 K STREET N.W., SUITE 700, WASHINGTON, DC, 20005, US

(21) Appl. No.: 11/267,307

(22) Filed: Nov. 7, 2005

(51) Int. Cl. G06Q 30/00

(52) U.S. Cl. 705/14

(57) ABSTRACT

Systems and method of providing online discount offer programs to users provide for receiving travel information associated with the user and presenting a set of discount offers to the user based on the travel information. A modified set of discount offers can be presented to the user in response to input from the user, where the input identifies a change in the travel information.

### BACKGROUND

1. Technical Field

Embodiments of this invention generally relate to advertising and travel. More particularly, embodiments of this invention relate to online discount travel offer programs.

2. Discussion

In the e-commerce industry, online discount programs have become a significant revenue-generating tool among merchants. An online discount program may enable the consumer to purchase discount packages, where the packages include discounts from a variety of merchants in a given geographic region. These packages are typically limited, however, to offers from merchants in the specific geographic region for the package purchased, making them of little use to consumers who may be traveling outside of the particular region. In addition, should the consumer be traveling within the region and wish to identify offers near a particular attraction, the traveler typically needs to know the address of the attraction in order to filter out the offers of interest. In many cases, such an address is either not known or difficult to determine, particularly if the individual is not from the region in question.

Although more recent solutions may attempt to combine travel information with discount offer programs, a number of difficulties remain. For example, one approach may be to link the discount package to the purchase of a fixed travel itinerary, where a travel arrangement confirmation page presents the consumer with the additional option of purchasing the discount package for the purchased trip. The purchased travel arrangements can therefore be used to set a geographic region and permissible usage period for the discount package. Should the traveler change his or her travel plans (e.g., change travel destination or travel dates), however, the purchased discounts may become useless to the traveler in question because the usage parameters of the discounts are generally fixed based on the original travel arrangements. Furthermore, the ability to identify offers near a particular attraction may continue to be a challenge for the consumer.

### BRIEF DESCRIPTION OF THE DRAWINGS

The various advantages of embodiments of the present invention will become apparent to one skilled in the art by reading the following specification and appended claims, and by referencing the following drawings, in which:

FIG. 1 shows a flowchart of an example of a method according to an embodiment of the present invention;

FIG. 2 shows a block diagram of an example of a system according to an embodiment of the present invention;

FIG. 3 shows an example of an interface used to purchase a discount package according to an embodiment of the invention;

FIG. 4 shows an example of a trip entry screen according to an embodiment of the invention;

FIG. 5 shows an example of a welcome screen used to present discount offers to a discount package purchaser according to an embodiment of the invention;

FIG. 6 shows an example of a trip management screen used by a discount package purchaser according to an embodiment of the invention;

FIG. 7 shows an example of a trip addition screen used by a discount package purchaser according to an embodiment of the invention;

FIG. 8 shows an example of a discount browsing screen used by a discount package purchaser according to an embodiment of the invention;

FIG. 9 shows an example of a discount listing screen used by a discount package purchaser according to an embodiment of the invention;

FIG. 10 shows an example of a tool used by a discount package purchaser for searching for discount offers near an attraction according to an embodiment of the invention;

FIG. 11 shows an example of a discount offer information screen used by a discount package purchaser according to an embodiment of the invention; and

FIG. 12 shows an example of a print discount offer screen used by a discount package purchaser according to an embodiment of the invention.

### DETAILED DESCRIPTION

Embodiments of the present invention solve a number of challenges through a method and apparatus that enables meaningful partnerships and communication between consumers, remote merchants and travel providers. The merchants may provide a wide variety of goods and/or services such as dining, entertainment, shopping, etc. Embodiments allow consumers to discover, either in conjunction with travel arrangements or independently, discount offers from merchants in remote locations. These discounts may be stored in a server and can be provided to the consumer based on the consumer's travel plans. If the consumer then changes their travel plans, the set of offers available may subsequently change to reflect those changes. The embodiments are therefore highly flexible.

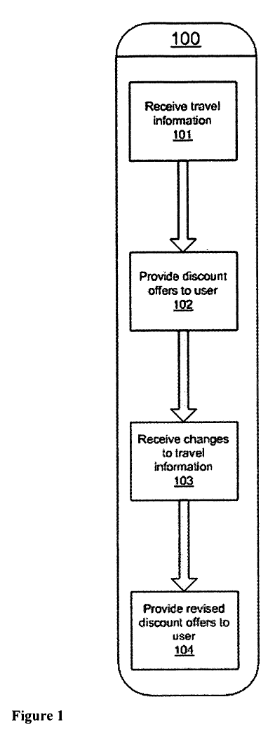

FIG. 1 shows one embodiment of the present invention at method 100. The method 100 may be implemented in a discount program server as hardware, firmware, software, etc., or any combination thereof. For example, the method 100 may be implemented as a set of instructions stored in a machine readable medium such as a read only memory (ROM), random access memory (RAM), flash memory, etc., where the instructions are capable of being executed by a processor to provide online discount offers to a remote user/consumer. In another example, the method 100 may be implemented as fixed functionality hardware such as an embedded microcontroller using complementary metal oxide semiconductor (CMOS) technology, transistor-transistor logic (TTL) technology, and so on.

In general, the consumer is able to purchase access to a discount offer program, where the illustrated embodiment provides for receiving travel information at processing block 101. The travel information may include a travel destination and an initial travel start date. A set of discount offers may then be selected and provided to the consumer at block 102 based on the travel information so that the consumer receives a set of trip-specific offers. For example, the consumer may have a trip planned to West Hollywood, California in mid-November, and may be interested in dining discounts near this travel destination during this time period. In such a case, the offers provided to the consumer at block 102 could be limited to discount offers from restaurants in the West Hollywood area. The set of discount offers may include one or many offers and could include discounts such as fifty percent off, buy one get one free, etc. The expiration date of the offers provided to the consumer at block 102 may also be time-sensitive based on the travel date. For example, the offers may be made to be valid only during the period of time around the travel dates. Thus, in the example above, the offers could be made to be valid from mid-November to, for example, the beginning of December. The use of travel information such as destination location and travel date to provide discount offers to consumers results in a robust coupon solution that can add significant value to consumer travel bookings.

Block 103 demonstrates that the consumer may change their travel information so that the travel information changes are received at block 103, and in response, the set of discount offers changes. For example, the consumer may wish to research offers for another time period, where a new travel start date is received at block 103. In another example, the consumer may decide to travel to a different destination, where a new travel destination is received at block 103. Indeed, the consumer may simply decide to visit a different location while on the trip to the initial destination, and input new travel information accordingly in order to get a listing of new discounts. In yet another example, the consumer could be traveling to the destination by automobile and in need of discounts at an intermediate geographic location. In any event, the revised discount offers can be presented to the user at block 104, where the revised discount offers reflect the change in travel plans. Enabling the consumer to modify the travel information “on-the-fly” and after purchase of the discount package provides consumers with much more flexibility and represents a substantial departure from conventional approaches.

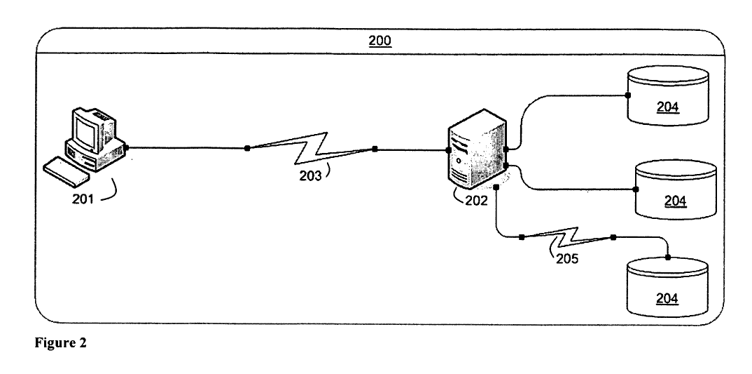

FIG. 2 shows one embodiment of the present invention as system 200. In the illustrated embodiment, a client computer system 201 is connected to a discount program server computer system 202 through a network 203. The server computer system 202, which may be separate from and independent of the system of any particular merchant and/or service provider, can be connected to a database 204 containing offers and travel information for a wide variety of merchants. In practice, the database 204 may actually be multiple databases, each containing subsets of that information. Further, the databases 204 may be stored on computer readable media within the server computer system, they may be connected directly to the server computer system 202, or they may be connected through a network 205. Network 205 may be the same or different than network 203. In practice, these networks 203 and 205 are implemented as Ethernet networks, token-ring networks, wireless networks, the Internet or any other networking system. Client computer system 201 and server computer system 202 may be any of the many computing devices used in practice today. Similarly, database 204 may be a separate computing device, a software based component or merely computer readable media.

Turning now to FIG. 3, one embodiment of the invention includes purchasing a discount package directly from a discount package merchant through a purchase form 300. The discount package merchant may be independent from any particular merchant and/or service provider, where the discount package merchant uses a discount program server computer system 202 (FIG. 2) to present offers to consumers. In this embodiment, the consumer enters personal information in the consumer information box 301. The personal information can include a password, identification information, (e.g., name, contact information, email address) and billing information (e.g., credit card number). The personal information can be used to generate a profile for user, where the profile may be updated by the user as needed. When the consumer is finished entering the personal information, the consumer can complete the step by clicking the information box submission button 302, which provides them with access to the database of discount offers (assuming financial approval). In the illustrated example, no travel information is required at the time of purchase.

In one embodiment, once the consumer has purchased a discount package, the consumer is presented with a trip entry form 400. In this embodiment, the consumer fills out the destination detail section 401, the travel date section 402, and then selects the trip submission link 403. In the illustrated example, the discount offers to be presented to the consumer are selected based on the travel destination, and the travel start date is used to set the expiration date of the discount offers. In particular, the discounts will expire two weeks after the travel start date in the example shown. Shorter, longer, or unlimited periods of discount availability may alternatively be used. Both the travel destination and the travel start date may be subsequently changed by the consumer. In fact, the consumer may also search for discounts around specific attractions (e.g., museums, venues, neighborhoods, monuments, etc.) within any selected travel destination. In one embodiment, the travel date may only be modified prior to use of the print discount link 1104 or the print discount screen 1200.

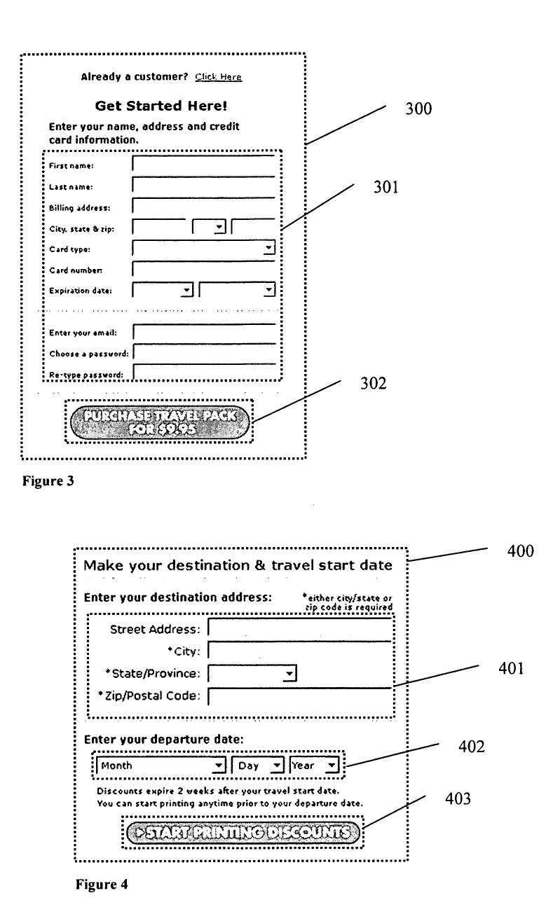

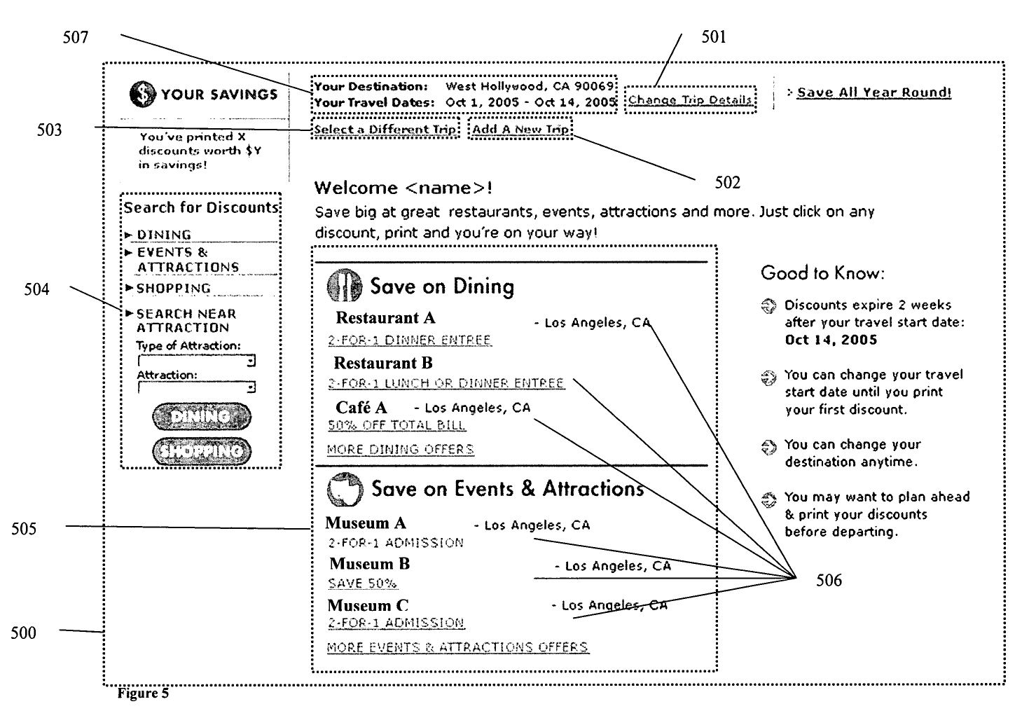

At this point, the user may be presented with a welcome screen 500 as shown in FIG. 5. From the welcome screen 500, the user may select from a variety of options. These options include changing the details of their trip (by use of the change trip details link 501), adding a new trip (by use of the add a new trip link 502), selecting a different trip (by use of the select a different trip link 503), searching for discount offers (by use of the search for discounts interface 504) or selecting a discount offer 506 from the suggested offer box 505. The details already entered by the user in the trip entry form 400 (FIG. 4) are displayed in the trip details box 507. In addition, a “currently browsing” box (not shown) may be included to indicate to the user the geographic region for which they are currently viewing discounts. In this regard, the user may be able to freely browse discounts in locations other than the trip destination.

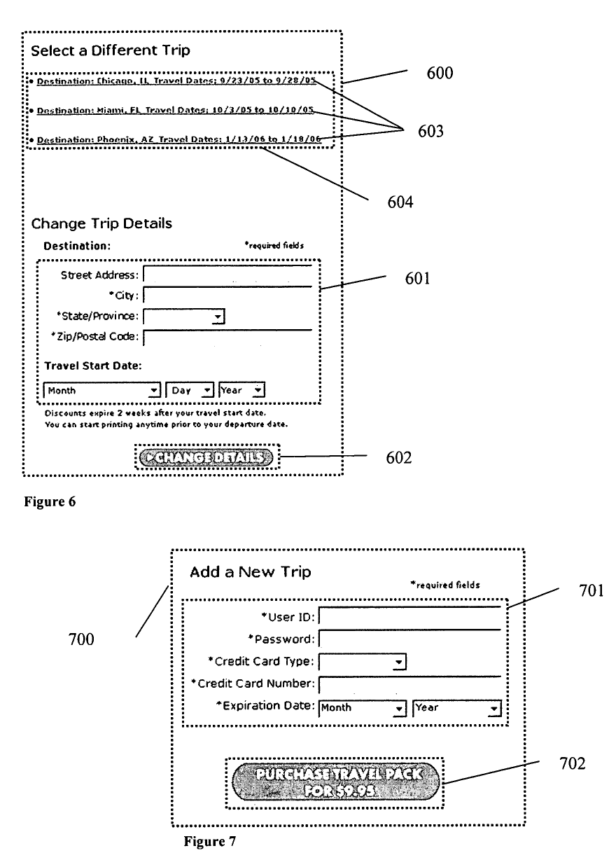

Selecting the change trip details link 501 can lead the user to the trip management screen 600 shown in FIG. 6. The user may enter new information into trip change form 601 and use a change details submission link 602 to submit the new information. The input provided via the trip change form 601 identifies a change in the user's travel information, which may cause a modified set of discount offers to be presented to the user. In one embodiment, the trip change form 601 is not available if the user has already printed out a coupon.

Selecting the select a different trip link 503 (FIG. 5) can also lead a user to the trip management screen 600 shown in FIG. 6. From there, the user may select a trip identification link 603 from the list provided in the trip listing box 604. Selecting a trip identification link 603 may return the user to the welcome screen 500 shown in FIG. 5, with the travel destination, travel start date and discount offers modified accordingly.

Selecting the add a new trip link 502 (FIG. 5) with the travel destination, travel start date and discount offers modified accordingly leads a user to the trip addition screen 700 shown in FIG. 7. A user enters information regarding the new trip in the new trip form 701 and submits it using the new trip submission link 702. This option results in the purchase of a new discount package. The user may be returned to the welcome screen 500 shown in FIG. 5 after submission of the new trip details.

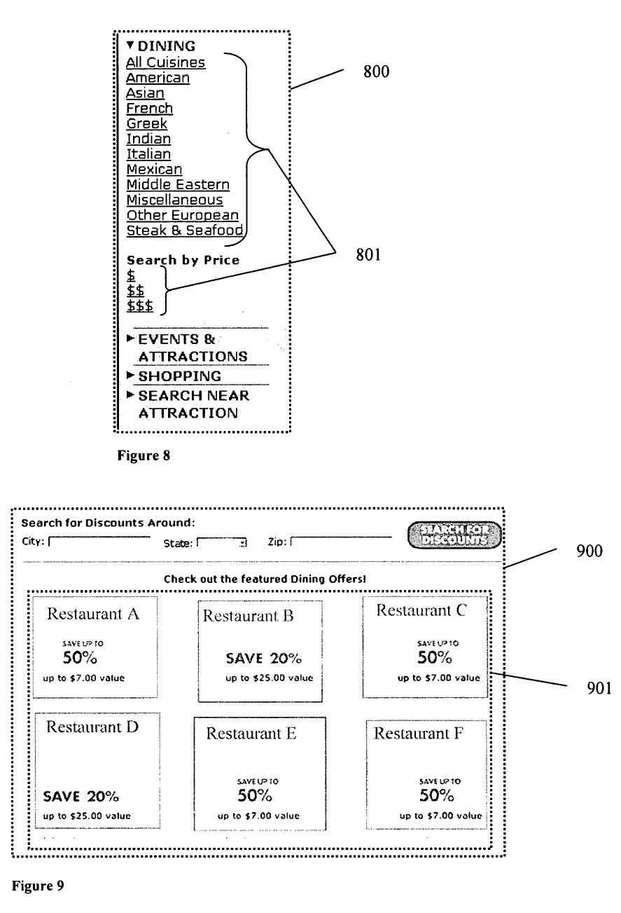

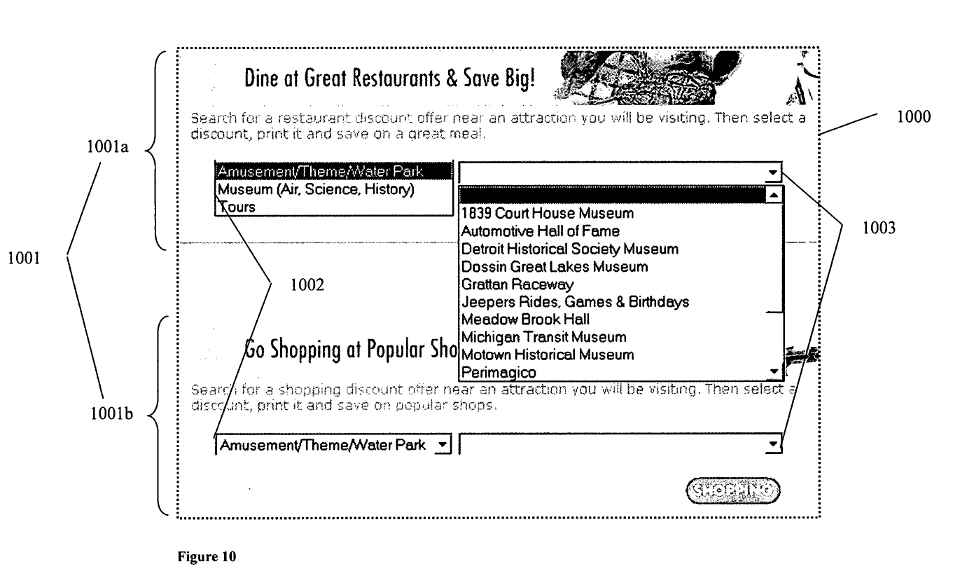

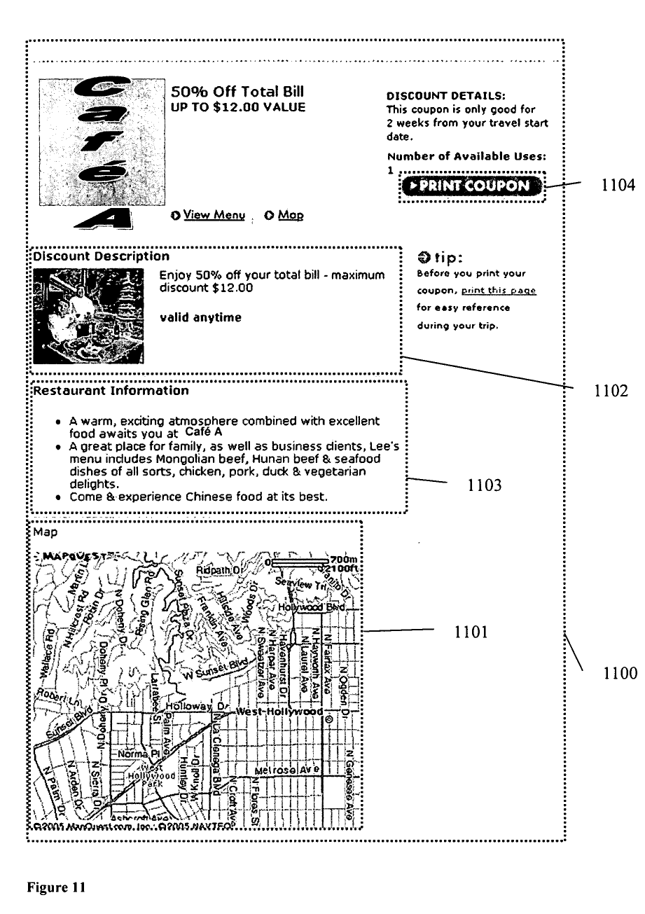

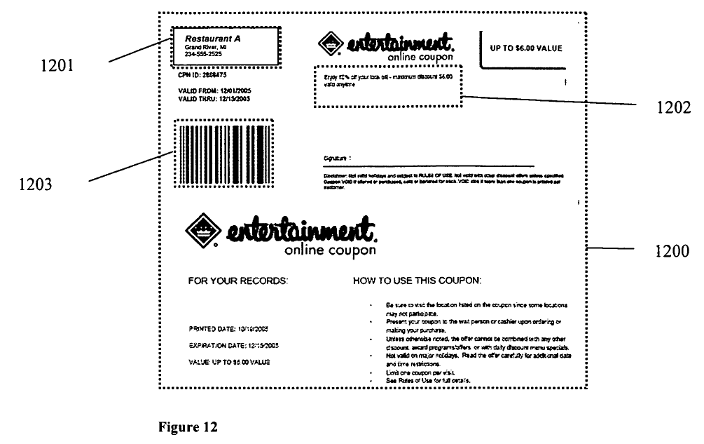

By selecting any options within the search for discounts interface 504 (FIG. 5), the user initiates either a browse discounts screen 800, as shown in FIG. 8, or a search near attractions screen 1000, as shown in FIG. 10. The illustrated browse discounts screen 800 displays to the user a number of discount subcategories 801 related to the item selected in the search for discounts interface 504 (FIG. 5). Selecting an item from the discount subcategories 801 leads the user to a discount listing 900, as shown in FIG. 9. The discount listing 900 includes a number of discount offers 901. Selecting any of the discount offers 901 will lead the user to a related discount offer information screen 1100, as shown in FIG. 11.

If a user selects an option within the search for discounts interface 504 (FIG. 5) that leads to the search near attractions screen 1000, as shown in FIG. 10, they may be presented with a number of offer category selection boxes 1001, including within each an attraction type selection box 1002, an attraction listing box 1003 and an attraction submission link 1004. In one embodiment, the search near attractions screen 1000 includes several offer category selection boxes 1001 (1001a, 1001b) covering a number of different categories of discounts. Examples include a “dining” offer category selection box 1001a, which enables a user to locate dining offers from restaurants or fast food locations near an attraction that they may be visiting, a “shopping” offer category selection box 1001b, which enables a user to locate shopping discount offers from retail merchants near a particular attraction, and so on. Examples of other types of offer selection categories include, but are not limited to, an “entertainment” offer category selection box enabling a user to locate discounts from movie theaters or live action theaters near an attraction, and a “lodging” offer category selection box 1001 enab ling a user to locate discounts from hotels, motels, or campgrounds near an attraction.

Each offer category selection box 1001 may contain an attraction type selection box 1002, where each attraction type selection box 1002 can be populated with different types of attractions. In the illustrated example, the attraction type selection box 1002 within the “dining” and “shopping” offer category selection boxes 1001 give the user the option of searching around amusement/theme/water parks, museums and tours. Other types of attractions such as venues, neighborhoods, and historical landmarks can also be used. Selecting an attraction type from the attraction type selection box 1002 populates the attraction listing box 1003 with attractions that fall within the selected attraction type. Thus, in one example, selecting “neighborhoods” from an attraction type selection box 1002 would populate the related attraction listing box 1003 with names of various neighborhoods. In another example, selecting “tours” from an attraction type selection box 1002 could populate the related attraction listing box 1003 with organized tours of various historical places. The related attraction listing box 1003 could be designed to list paid advertisers/partners and/or non-paid attraction sites.

Each attraction type selection box 1002 may be populated with different types of attractions, related and unrelated to the surrounding offer category selection box 1001. For example, an attraction type selection box within an entertainment offer category selection box might contain entertainment-related entries such as “water parks” and “arcades”, but may also include non-entertainment entries such as “hotels”, “airports” or “neighborhoods”.

Selecting an attraction from the attraction listing box 1003 leads a user to a discount listing screen 900 (FIG. 9) containing a number of discount offers 901 that fall within the category of the offer category selection box 1001 and are also geographically near the attraction selected in attraction listing box 1003. Selecting a discount offer 901 leads the user to a discount offer information screen 1100 as shown in FIG. 11.

By way of example, if a user has determined that he is traveling to Chicago, Ill. and wishes to find dining discounts near the Navy Pier, he might navigate to the “Dining” offer category selection box 1001a and select “Historical Landmarks” from the attraction type selection box 1002. The attraction listing box 1003 will be populated with the historical landmarks in the Chicago area, including the Navy Pier. Upon selecting the Navy Pier item in the attraction listing box 1003, the user will be taken to a listing of dining discount offers near the Navy Pier.

In another example, if a user is traveling to Washington, D.C. and wishes to find shopping discounts near her hotel, she might use the “Shopping” offer category selection box 1001b, then she might select “hotels” from the associated attraction type selection box 1002 and then choose her hotel from the now-populated attraction listing box 1003. This would lead the user to a discount listing screen 900 (FIG. 9) listing all shopping related discount offers geographically near her hotel.

In yet another embodiment, the user might wish to find restaurants near the neighborhood in which her late business meeting will be held. By using the “Dining” or “Restaurant” offer category selection box 1001, then choosing “Neighborhood” from the attraction type selection box 1002 and then selecting the neighborhood of choice from the attraction listing box 1003, the user will be shown a discount listing screen containing discount offers for restaurants in the selected neighborhood. Alternatively, the user could be presented with an attraction type selection box first, and then select different categories of offers (or all offers) as a subset. Other such variations may also be made in the user interface.

The illustrated discount listing screen 900 (FIG. 9) can therefore be used to list discounts within several contexts, including listing the discounts within a discount subcategory (as selected from the browse discounts screen 800) and listing the discounts that are geographically near an attraction (as selected from the attraction selection box 1003).

Selecting a discount offer 506 from the suggested offer box 505 in FIG. 5 leads the user to a related discount offer information screen as shown in FIG. 11 in the same manner as when a user selects discounts offers 901 from the discount listing screen shown in FIG. 9.

The discount offer information screen 1100, as shown in FIG. 11, displays to the user useful information related to a particular discount offer 901 selected from a discount listing screen. Such information may include a map 1101 to the merchant location, a discount offer description 1102, a merchant description 1103, and a print discount link 1104. Selecting the print discount link 1104 leads the user to a print discount screen 1200, as shown in FIG. 12.

The illustrated print discount screen 1200, as shown in FIG. 12, contains a number of the same elements as the discount offer information screen but is formatted in a manner to make printing more convenient. The print discount screen includes the merchant address 1201, discount offer description 1202 and a discount bar code identifier 1203.

Although embodiments of the present invention have been disclosed in detail, it should be understood that various changes, substitutions, and alterations may be made herein, and the present invention is intended to cover various modifications and equivalent arrangements. Other examples are readily ascertainable from the above description by one skilled in the art and may be made without departing from the spirit and scope of the present invention as defined by the following claims.

What is claimed is:

1. A method of providing an online discount offer program to a user comprising:
receiving travel information associated with the user;
presenting a set of discount offers to the user based on the travel information; and
presenting a modified set of discount offers to the user in response to input from the user, the input identifying a change in the travel information.

2. The method of claim 1, further including:
prompting the user with a list of attractions associated with the travel information;
receiving a user selection of at least one of the attractions; and
generating the modified set of discount offers based on the user selection.

3. The method of claim 2, wherein the list of attractions is selected from a group comprising museums, amusement parks, sports venues, concert halls and monuments.

4. The method of claim 1, wherein the receiving includes receiving an initial travel destination and the change includes a user selection of a new travel destination.

5. The method of claim 1, wherein the receiving includes receiving a travel date and the change includes a user selection of a new travel date.

6. The method of claim 5, further including establishing an expiration date of the modified set of discount offers based on the new travel date.

7. The method of claim 1, wherein the presenting of the modified set of discount offers is conducted after the user has purchased access to the discount offers.

8. The method of claim 1, further including:
enabling the user to print one or more coupons associated with the modified set of discount offers;
permitting the change in the travel destination if the change does not include a user selection of a new travel date; and
preventing the change in the travel destination if the change includes a user selection of a new travel date.

9. A method comprising:
confirming that a user has purchased access to an online discount offer program;
receiving travel information associated with the user, the travel information including an initial travel destination and an initial travel start date;
selecting an initial set of discount offers based on the initial travel destination and the initial travel start date;
establishing an expiration date of the initial set of discount offers based on the initial travel start date;
presenting the initial set of discount offers to the user;
receiving input from the user that identifies a change in the travel information;
selecting a modified set of discount offers based on the change in the travel information; and
presenting the modified set of discount offers to the user.

10. The method of claim 9, wherein receiving the input that identifies the change includes receiving input that identifies a new travel date, the method further including establishing a modified start date of the modified set of discount offers based on the new travel date.

11. The method of claim 9, wherein receiving the input that identifies the change includes receiving input that identifies a new travel destination.

12. The method of claim 11, further including prompting the user with a list of attractions selected based on at least one of the initial travel destination and the new travel destination.

13. A computer system, comprising:
a processor;
a first memory coupled to said processor to store a database of discount offers and instructions adapted for the purpose of receiving travel information, retrieving a first set of said discount offers related to said travel information from said database, receiving changes to said travel information, retrieving a second set of said discount offers related to said changes to travel information from said database and transmitting said sets of discount offers.

14. The computer system of claim 13, further including;
a network interface coupled to said processor and capable of communicating with a network; and
a second processor;
a second memory coupled to said second processor to store instructions adapted for the purpose of transmitting travel information, receiving said first set of discount offers, instructions adapted for the purpose of transmitting changes to said travel information, receiving said second set of discount offers; and
a second network interface coupled to said second processor capable of communicating with said network.

15. The computer system of claim 14, wherein the first memory further stores instructions adapted to establish an expiration date of the sets of discount offers based on said travel information and said changes to travel information.

16. The computer system of claim 13, wherein the travel information includes a travel date and the changes include a user selection of a new travel date.

17. The computer system of claim 13, wherein said travel information includes a travel destination and said changes to travel information include changes to said travel destination.

18. The computer system of claim 13, wherein said travel information includes a user selection of an attraction.

19. The computer system of claim 13, wherein the first memory further stores instructions adapted for the purpose of facilitating a purchase of a discount package and instructions permitting the transmittal of discount offers only after said purchase of a discount package has occurred.

20. The computer system of claim 13, wherein the first memory further stores instructions adapted for the purpose of presenting discount offers in a printable form and prohibiting the receipt of changes to travel information after discount offers have been presented in printable form.
